(19) United States
(12) Patent Application Publication
(10) Pub. No.: US 2015/0063694 A1
(43) Pub. Date: Mar. 5, 2015

(54) TECHNIQUES FOR COMBINING IMAGES WITH VARYING BRIGHTNESS DEGREES

(71) Applicant: QUALCOMM Incorporated, San Diego, CA (US)

(72) Inventors: Nitesh SHROFF, San Diego, CA (US); Ramin REZAIIFAR, Del Mar, CA (US); Piyush SHARMA, San Diego, CA (US); William Edward MANTZEL, San Diego, CA (US)

(73) Assignee: QUALCOMM Incorporated, San Diego, CA (US)

(21) Appl. No.: 14/254,770

(22) Filed: Apr. 16, 2014

Related U.S. Application Data
(60) Provisional application No. 61/872,560, filed on Aug. 30, 2013.

(51) Int. Cl. G06T 11/60

(52) U.S. Cl. CPC G06T 11/60
USPC 382/167

(57) ABSTRACT

Techniques are described for combining two or more images that are taken with varying brightness degrees to generate a composite image. In one embodiment, at least two weight masks are generated based on one or more characteristics of the two or more images. A first image A first weight mask is used to combine color channels of one or more pixels of the two or more images and a second weight mask is used to combine intensity channels of the one or more pixels of the two or more images.

### CROSS-REFERENCE TO RELATED APPLICATIONS

The present application claims priority to Provisional Application No. 61/872,560, entitled “Method and Apparatus for Combining Flash and Ambient Images,” filed Aug. 30, 2013, which is assigned to the assignee hereof and expressly incorporated by reference herein in its entirety.

### TECHNICAL FIELD

The present disclosure relates generally to digital photography, and in particular, to combining two or more images that are captured with varying brightness degrees.

### BACKGROUND

An important goal of photography is to capture and reproduce the visual richness of a real environment (e.g., true colors, lighting, etc.). When capturing the natural ambient illumination in low-light environments, if exposure times are short, the camera cannot capture enough light to accurately estimate the color at each pixel. Therefore, visible image noise increases significantly. One solution for capturing a visible image would be to set a long exposure time on the camera and/or increase gain of the camera by varying the ISO setting. However, camera shake or scene motion may result in motion blur in the image. Another option would be opening the aperture in low-light conditions, which may result in reduced depth of field.

Flash photography was invented to circumvent these problems. By adding artificial light to nearby objects in the scene, cameras with flash can use shorter exposure times, smaller apertures, and less sensor gain and still capture enough light to produce relatively sharp, noise-free images. Brighter images have a greater signal-to-noise ratio and can therefore resolve detail that would be hidden in the noise in an image acquired under ambient illumination. Moreover, the flash can enhance surface detail by illuminating surfaces with a crisp point light source. However, use of flash can also have negative impacts on the lighting characteristics of the environment. For example, objects near the camera are disproportionately brightened. In addition, the flash may introduce unwanted artifacts such as red eye, harsh shadows, and specularities, none of which are part of the natural scene.

Today, digital photography makes it fast, easy, and economical to take two or more images from a scene with different light settings. However, efficiently combining these images remains a challenge.

### SUMMARY

Certain embodiments present a method for generating a composite image by combining a first image of a scene with a second image of the scene. The method may include, in part, generating a first weight mask for combining color information of a pixel in the first image with color information of a corresponding pixel in the second image, wherein the first image is taken with first brightness degree and the second image is taken with a second brightness degree, generating a second weight mask for combining intensity information of the pixel in the first image with intensity information of the corresponding pixel in the second image, wherein the first and the second weight masks are generated based on characteristics of a neighborhood around the pixel in the first and the second images, and generating the composite image by combining color and intensity information of the pixel in the first and the second images using the first and the second weight masks.

In one embodiment, the characteristics of the neighborhood around the pixel comprise at least one of exposure, richness of color, sharpness and texture of a plurality of pixels in the neighborhood around the pixel. The characteristics of the neighborhood around the pixel may also include information about a discount region with pixels that are affected by specular reflections.

In one embodiment, the first image is taken with flash and the second image is taken with ambient light. Furthermore, the first weight mask is biased towards the second image and the second weight mask is biased towards the first image.

In one embodiment, the first image is taken using a first ISO gain and the second image is taken using a second ISO gain. In addition, one of the first or the second images are taken with flash.

Certain embodiments present an apparatus for generating a composite image by combining a first image of a scene with a second image of the scene. The apparatus includes, in part, means for generating a first weight mask for combining color information of a pixel in the first image with color information of a corresponding pixel in the second image, wherein the first image is taken with a first brightness degree and the second image is taken with a second brightness degree, means for generating a second weight mask for combining intensity information of the pixel in the first image with intensity information of the corresponding pixel in the second image, wherein the first and the second weight masks are generated based on characteristics of a neighborhood around the pixel in the first and the second images, and means for generating the composite image by combining color and intensity information of the pixel in the first and the second images using the first and the second weight masks.

Certain embodiments present a non-transitory processor-readable medium for generating a composite image by combining a first image of a scene with a second image of the scene. The processor readable medium includes, in part, processor-readable instructions configured to cause a processor to generate a first weight mask for combining color information of a pixel in the first image with color information of a corresponding pixel in the second image, wherein the first image is taken with a first brightness degree and the second image is taken with a second brightness degree generate a second weight mask for combining intensity information of the pixel in the first image with intensity information of the corresponding pixel in the second image, wherein the first and the second weight masks are generated based on characteristics of a neighborhood around the pixel in the first and the second images and generate the composite image by combining color and intensity information of the pixel in the first and the second images using the first and the second weight masks.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects of the disclosure are illustrated by way of example. In the accompanying figures, like reference numbers indicate similar elements.

FIG. 1 illustrates an example high level block diagram of an image processing method, in accordance with certain embodiments of the present disclosure.

FIG. 2 illustrates an example block diagram of an image combining technique, in accordance with certain embodiments of the present disclosure.

FIG. 3 illustrates example operations that may be performed by a device to combine images, in accordance with certain embodiments of the present disclosure.

FIGS. 4A-4C show example images that are captured with flash, without flash, and an example combined image using the image combining technique presented herein, in accordance with certain embodiments of the present disclosure.

FIG. 5 describes one potential implementation of a device which may be used to combine images, according to certain embodiments.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

An image combining technique is presented for combining images that are taken with different brightness degrees to generate a composite image with higher quality. For example, an image that is taken from a scene without flash (e.g., using ambient light) and another image that is taken with flash from the same scene can be combined by utilizing the image combining technique as described herein.

In general, each of the images that are taken with different brightness degrees have their own advantages and/or disadvantages. For example, an image that is taken without flash (hereinafter referred to as ‘ambient image’ usually has better color. The ambient image can reproduce true colors of the scene. However, depending on the ambient light, the ambient image can be noisy and/or dark. On the other hand, an image that is taken with flash (hereinafter referred to as ‘flash image’), may be bright and/or less noisy compared to the ambient image. However, the flash image may not show true colors of the scene. In addition, specularities of flash may be seen in the flash image.

Advancements in digital photography makes it possible to take multiple images from the same scene with different camera settings. The images may then be combined to generate a composite image. If done properly, the composite image can have better quality than each of the original images. The image combining method according to one embodiment, lakes advantage of positive characteristics of each of the images (e.g., ambient age and/or flash image) to generate a high-quality image. In one embodiment, the ambient image and the flash image are fused seamlessly. In one embodiment, true colors of the scene are reproduced in the composite image, which can be brighter and less noisy compared to the ambient image. The image combining technique as described herein, can be considered as a method of using flash in photography while being able to preserve true colors of the scene an/or the subject of photography. This could be very useful in low-light imaging and/or photography.

Current techniques in the art rely on de-noising the ambient image and transferring detail from the flash image to the ambient image. Other methods use gradient projection to remove reflections. However, each of these techniques loses some of the characteristics of the images while combining the images.

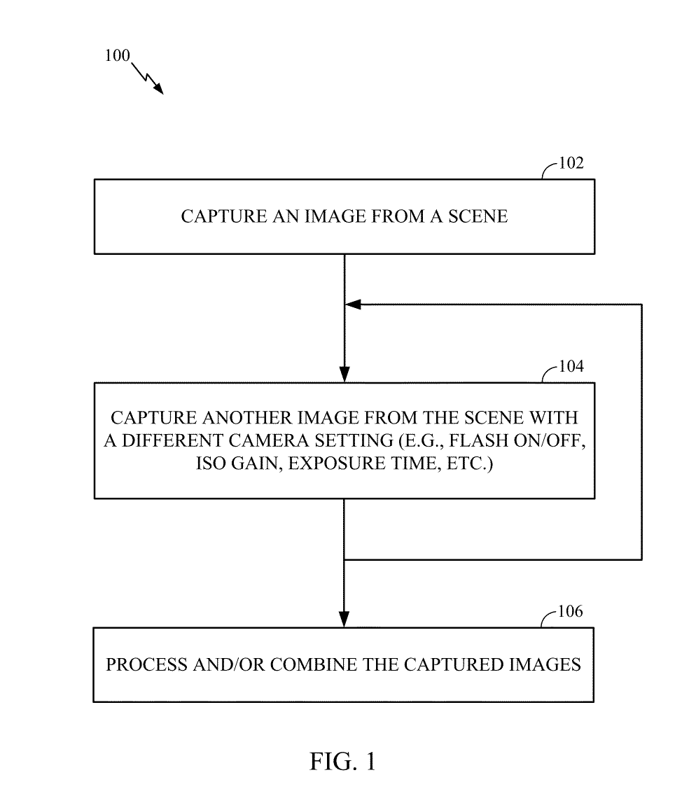

FIG. 1 illustrates an example high level flow diagram 100 that can be performed by an image capturing device, in accordance with certain embodiments of the present disclosure. As illustrated, in block 102, the device captures an image from a scene using a camera. The device may then capture another image from the scene with a different camera setting. For example, the device may take images with and/or without flash, with different ISO gains, with different exposure times, and the like (block 104). The device may process the captured images to reduce/eliminate artifacts that are present in the captured images (block 106). For example, the device may process and/or combine the images using the image combining technique as described herein to generate a composite image with a higher quality than each of the original images, in general, the device may capture any number of images from the same scene with different settings and combine them without departing from the teachings of the present disclosure.

In general, a YUV or an RGB (red-green-blue) color space may be used to represent information about each pixel in an image, YUV usually encodes a color image or video taking human perception into account, allowing reduced bandwidth for chrominance components. In YUV, Y channel represents brightness of a pixel and U and V channels represent color of the pixel (which are also referred to as chrominance or ‘chroma’). Although some of the discussion in the present disclosure refers to YUV color space representation, other color spaces may also be used to represent the images. In this document, the term ‘intensity channel’ represents the data corresponding to brightness of each pixel. Similarly, the term ‘color channel’ represents data corresponding to color information for a pixel.

One embodiment generates two weight masks for combining two or more images that are taken with different brightness degrees. For example, if a first image is taken with flash and a second image is taken with ambient light, the first weight mask can be used to combine color channels (e.g., channels U and V) of each pixel in the flash image with a corresponding pixel in the ambient image. In addition, the second weight mask can be used to combine intensity channel (e.g., brightness channel Y) of the pixel in the flash image with the intensity channel of a corresponding pixel in the ambient image. This is motivated by the fact that flash images typically have good intensity channels associated with them. However, the colors in the flash images are often low in quality. On the other hand, ambient images are known to preserve the true colors of the scene. But, the intensity channel of the ambient images may be noisy and dark when the scene does not have enough ambient light.

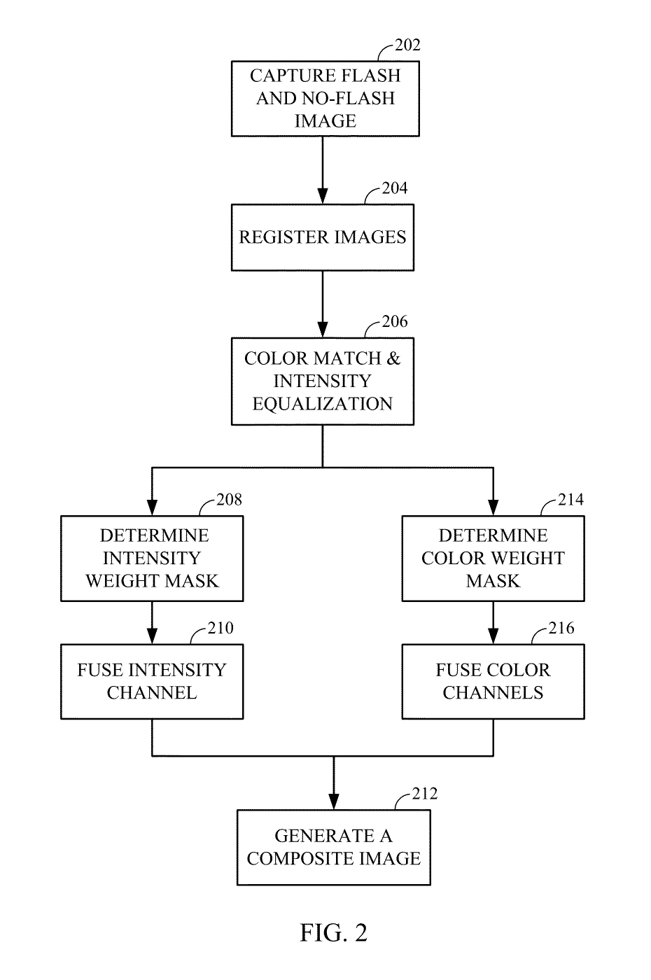

FIG. 2 illustrates an example block diagram of the image combining technique, in accordance with certain embodiments of the present disclosure. In this example, at 202, a device captures an image with flash and another image without flash (with only ambient light) from the same scene. It should be noted that the two images should have at least some overlapping sections. The image combining technique as described herein can be applied on the overlap between the two images. In one embodiment, the images are taken from a scene with different setting with limited delay.

At 204, the device registers the images. Tillage registration refers to the process of transforming different sets of data into one coordinate system. In general, data may be multiple photographs, data from different sensors, times, depths, or viewpoints. Image registration enables the device to compare and/or integrate the data obtained from different measurements. Several methods exist for registering images, such as intensity-based registration, feature-based registration, and the like. Generally, one of the images is considered as a reference image and the other images are spatially registered to align with the reference image. Intensity-based methods compare intensity patterns in images via correlation metrics. Feature-based methods find correspondence between image features such as points, lines, contours, etc. It should be noted that in general, any image registering technique can be used to align the images without departing from the teachings of the present disclosure.

At 206, the device may perform color matching and/or intensity equalization on the images. Color matching is the process of adjusting colors in two images in order to maintain a consistent look in a series of images from a scene. Intensity equalization increases the global contrast of images, especially when the usable data of the image is represented by close contrast values. Through Intensity equalization, most frequent intensity values are spread over a larger range.

The ambient and flash images are usually captured in very different lighting scenarios. The ambient image is typically dark, while the flash image is very well illuminated (at least in regions close to the flash source). It addition, the color temperatures of the two images are rarely the same. For example, ambient images are warmer and flash images are cooler (e.g., flash images have a blue tint). Fusing such images without compensating (or equalizing) for these differences can lead to unnatural images. In order to avoid such artifacts, one embodiment pre-processes the ambient and flash images (e.g., color match and intensity equalization) to bring the images closer to each other.

In one embodiment, the intensity channels (e.g., Y channel in YUV color space) of the ambient and flash images are equalized to reduce the differences in the local brightness levels of the corresponding areas in the two images. In one embodiment, this is achieved by computing a ratio r for each pixel, as follows:

r=F/A.

where F and A are average brightness in the neighborhood of each pixel (x, y) in the flash and ambient images respectively. In one embodiment, r may be transformed non-linearly to obtain a transformed ratio r′. For example, r′ may be defined as follows:

r′=0.25exp(−r/5.5)

In one embodiment, the corresponding pixel in the flash image may be multiplied by r′, and the corresponding pixel in the ambient image may be divided by r′. These operations bring the intensities of the two images closer to each other, hence avoiding any artifact in the combined image.

It should be noted that the intensity equalization technique as described above is a powerful tool which brightens up the dark regions of ambient image and tones down the bright regions of flash image. In one embodiment, to avoid loss of contrast and other artifacts, the ratio r is suppressed to be close to 1.0 using the nonlinear transformations explained above. In addition, one embodiment brightens up the ambient image by applying a non-linear lookup table to its intensity channel.

At 208, the device checks level of exposure in for each pixel in either of the images. For example, the device may determine an intensity weight mask based on the amount of exposure and/or brightness of a pixel. As an example, the intensity weight mask may be defined as a function of brightness of the pixel. Based on the intensity weight mask, the device may fuse intensity channels of the pixels in the two images (at 210) to determine intensity of the corresponding pixel in the composite image. At 214, the device may check color of each pixel and determine a color weight mask for the pixel. As an example, the color weight mask may be a function of the values in the color channels of one or more pixels. At 216, the device may fuse color channels of the images (e.g., U and V channels) based on the color weight mask to determine color of the corresponding pixel in the composite image (212).

In one embodiment, intensity weight mask W_{f} is defined corresponding to the flash image and intensity weight mask Wₐ is defined corresponding to the ambient image, as follows:

$${W}_{f 1} = \{ \begin{matrix}1 , & when {y}_{1} < {Y}_{f} < {y}_{2} , \\ ( 255 - {Y}_{f} ) \text{/} ( 255 - {y}_{2} ) & {Y}_{f} > {y}_{2} , \\ {e}^{( ( \frac{{Y}_{f}}{{y}_{1}} ) - 1 )} & {Y}_{f} < {y}_{1} .\end{matrix} \\ {W}_{f}^{raw} = {( {W}_{f 1} )}^{a} .$$

addition:

$${W}_{a 1} = \{ \begin{matrix}1 , & when {y}_{3} < {Y}_{a} < {y}_{4} , \\ ( 255 - {Y}_{a} ) \text{/} ( 255 - {y}_{4} ) & {Y}_{a} > {y}_{4} , \\ {e}^{( ( \frac{{Y}_{a}}{y 3} ) - 1 )} & {Y}_{a} < {y}_{3} .\end{matrix} \\ {W}_{a}^{raw} = {( {W}_{a 1} )}^{b} .$$

where y₁, y₂, y₃, y₄, a and b are constant values, Y_{f} represents pixel intensity in the flash image and W_{f}^{raw} represents a raw intensity weight mask for the flash image. Similarly, Yₐ represents pixel intensity in the ambient image and Wₐ^{raw} represents a raw intensity weight mask for the ambient image. W_{f1} and Wₐ₁ are intermediate values. In one embodiment, the following values can be used in the above equations: y₁=100, y₂=250, a=2, y₃=170, y₄=200, and b=3. It should be noted that any other values can also be used in the above equations without departing from the teachings of the present disclosure.

In one embodiment, the final intensity weight masks W_{f} and Wₐ can be defined as follows:

$${W}_{f} = \frac{{W}_{f}^{raw}}{{W}_{f}^{raw} + {W}_{a}^{raw}} , and$$

$${W}_{a} = \frac{{W}_{a}^{raw}}{{W}_{f}^{raw} + {W}_{a}^{raw}} .$$

In another embodiment, the final intensity weight masks W_{f} and Wₐ can be defined based on other raw intensity weight masks. For example, W_{f}^{raw} and Wₐ^{raw} can be defined as follows:

$${W}_{f}^{raw} = {( 1 - \frac{{Y}_{f} - {y}_{5}}{{y}_{5}} )}^{6}$$

$${W}_{a}^{raw} = {( 1 - \frac{{Y}_{a} - {y}_{5}}{{y}_{5}} )}^{6 }$$

where y₅ is a constant value (e.g., y₅=128).

It should be noted that the above intensity and color weight masks are mere examples and any other metric can be used to compare and/or combine properties (e.g., intensity, color, etc.) of the images without departing from the teachings of the present disclosure.

In one embodiment, a color weight mask can be defined as a sum of absolute values of the color channels in each pixel in each of the images. For example, for combining a flash image with an ambient image, the color weight mask may be defined as follows:

C_{f}=|U_{f}|+|V_{f}|,

Cₐ=|Uₐ|+|Vₐ|,

where C_{f} represents color weight mask corresponding to the flash image and Cₐ represents a color weight mask corresponding to the ambient image. U_{f} and V_{f} represent values in the U and V channels of the pixel in the flash image. Similarly, U, and V, represent values in the U and V channels of each pixel in the ambient image.

In one embodiment, intensity value Y, of each pixel in the composite image can be determined as follows:

Y_{c}=W_{f}×Y_{f}+Wₐ×Yₐ,

Wₐ+W_{f}=1.

Similarly, color values U_{c} and V_{c} of each pixel in the composite image can be determined as follows:

U_{c}=C_{f}×U_{f}+Cₐ×Uₐ,

V_{c}=C_{f}×V_{f}+Cₐ×Vₐ,

Cₐ+C_{f}=1.

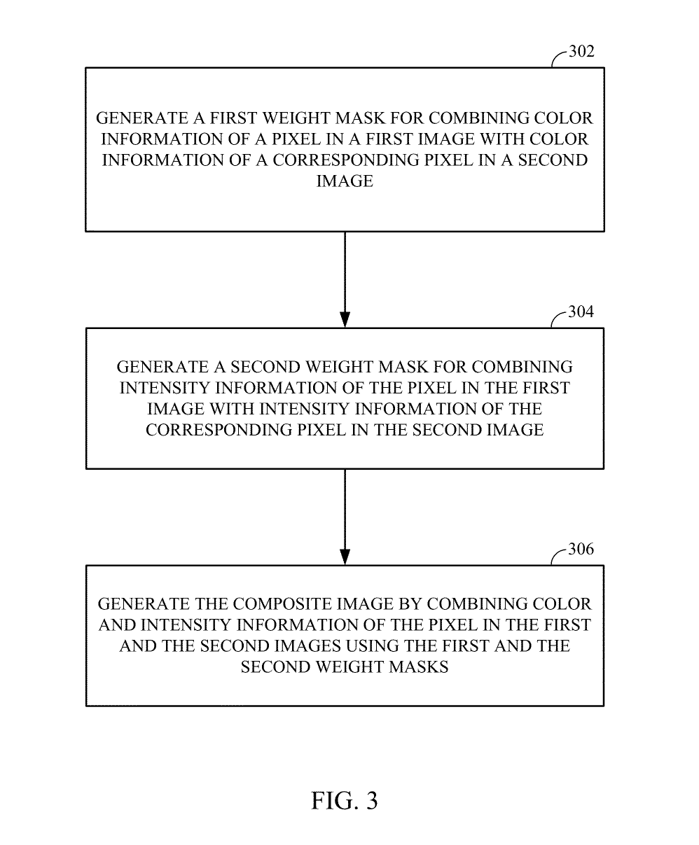

FIG. 3 illustrates example operations that may be performed by a device for generating a composite image by combining a first image of a scene with a second image of the scene, in accordance with certain embodiments of the present disclosure. At 302, the device generates a first weight mask (e.g., color weight mask) for combining color information of a pixel in the first image with color information of a corresponding pixel in the second image. For example, the first image is taken with a first brightness degree (e.g., using flash) and a second image is taken with a second brightness degree (e.g., without flash, using ambient light).

At 304, the device generates a second weight mask (e.g., intensity weight mask) for combining intensity information of the pixel the first image with intensity information of the corresponding pixel in the second image. In one embodiment, the first weight mask is biased towards the second image and the second weight mask is biased towards the first image.

In one embodiment, the first and the second weight masks are generated based on characteristics of a neighborhood around the pixel in the first and the second images. The characteristics of the neighborhood around the pixel may include exposure, richness of color, sharpness and texture of a plurality of pixels in the neighborhood around the pixel. In addition, the characteristics of the neighborhood around the pixel may include information regarding a discount region with pixels that are affected by specular reflections.

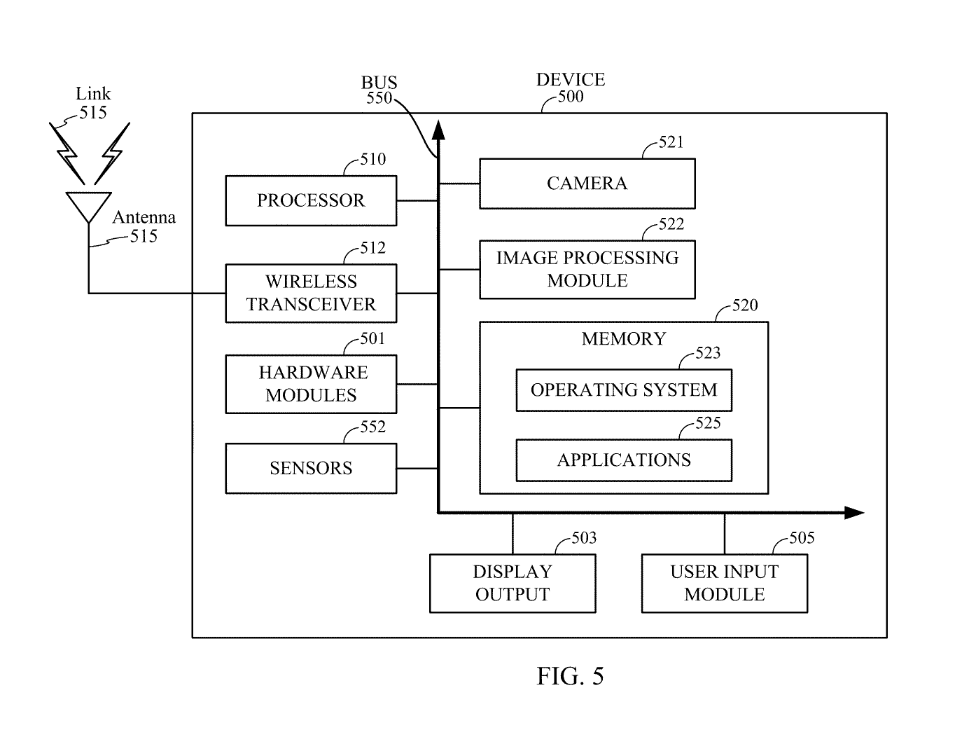

At 306, the device generates the composite image by combining color and intensity information of the pixel in the first and the second images using the first and the second weight masks. In general, any of the steps 302 through 306 may be performed, for example, by the image processing module 522, as illustrated in FIG. 5.

It should be noted that if a single weight mask is used to combine both the color and the intensity channels of the two images, the combining method performs very poorly. This is because a single weight mask either makes the fused image noisy or reduces the colorfulness of the fused image. On the other hand, the image combining technique as described herein achieves much higher quality′ by adjusting/calculating two different weight masks corresponding to the color and/or intensity channels. In addition, in one embodiment, the weight mask corresponding to the intensity channels can be biased towards the flash image, since the flash image usually has a better intensity. Similarly, weight masks corresponding to the color channels can be biased towards the ambient image, since the ambient image usually has a better color quality.

For certain embodiments one or more characteristics of the input images can be used to generate the weight masks. For example, a measure of well-exposedness of the pixels in a neighborhood of the pixel, richness of color of the pixels in the neighborhood of each pixel, and/or sharpness or texture in the neighborhood of the pixel can be considered in generating the weight masks. One embodiment brightens up parts of a scene while keeping the other sections unchanged. It may also reduce noise and preserve warmth of the scene.

By using two weight masks, certain embodiments asymmetrically equalize intensities of the flash and ambient images on a per-pixel basis. The equalization at each pixel may depend upon the ratio between the two intensities at that pixel. However, the equalization may not fully bring the two intensities together.

In one embodiment, when flash does not reach parts of the scene, the composite image is generated by similar procedures that are used in generation of high dynamic range (HDR) images. For example, when ambient image is too dark, the weight masks may be generated such that the composite image takes its color and brightness values from the flash image.

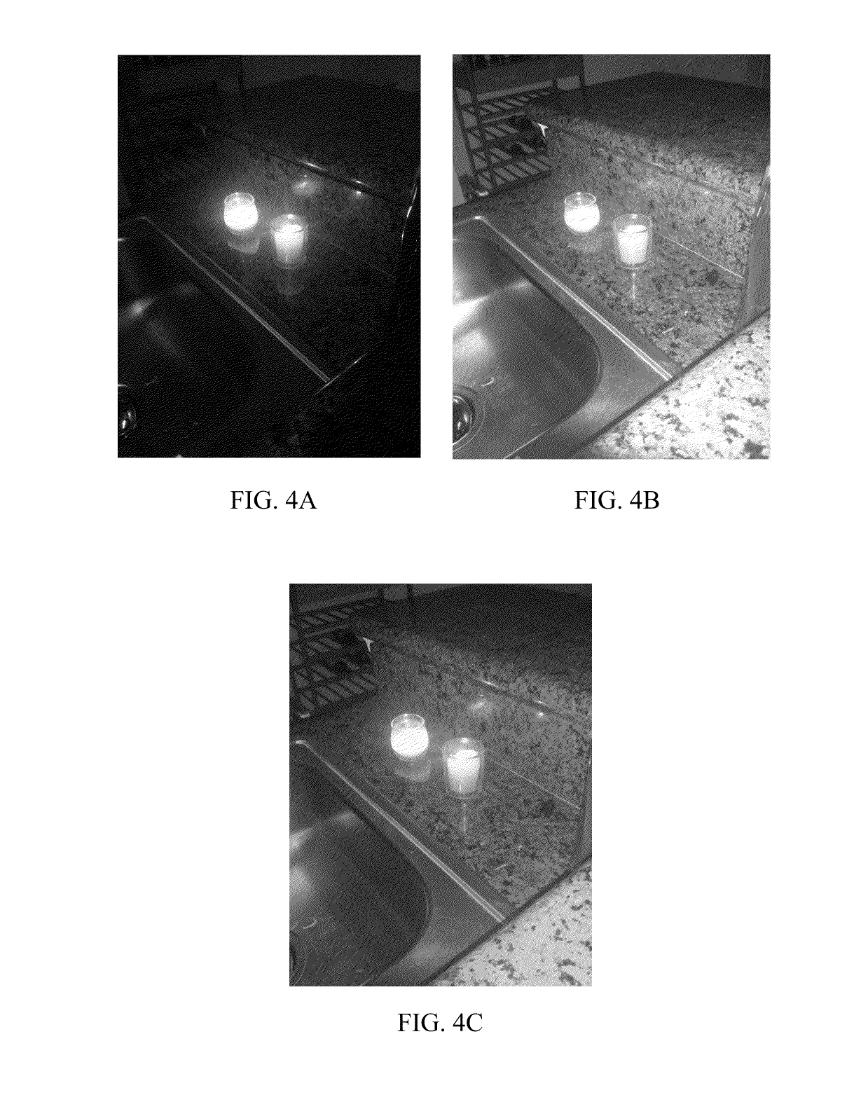

FIGS. 4A through 4C show example images taken with a flash (FIG. 4A), without a flash (FIG. 48), and an example composite image using the image combining technique described herein (FIG. 4C), in accordance with certain embodiments of the present disclosure. As can be seen, the image that is generated using the image combining technique has more light than the ambient image and shows true colors of the scene more accurately than the flash image.

It should be noted that although most of the examples in this disclosure refer to flash and/or ambient images, the teachings herein can be applied to any number of images that are taken with varying intensities of light sources (e.g., flashes). In addition, one or More of the images may be generated by varying the ISO (e.g., gain), rather than using a flash. In another embodiment, images may be taken using varying intensities of light sources (e.g., with flash, without flash and/or varying flash intensities) in addition to varying gain values. In general, the teachings herein may be used to generate a composite image from two or more images that are captured with varying brightness degrees by varying intensities of light sources (e.g., even using only the ambient light), varying amount of gain, varying exposure time and/or any other methods.

FIG. 5 describes one potential implementation of a device which may be used to combine images, according to certain embodiments. In one embodiment, device 100 as described in FIG. 1 may be implemented with the specifically described details of process 300. In the embodiment of device 500 shown in FIG. 5, specialized modules such as camera 521 and image processing module 522 may include functionality needed to capture and process images using the image combining technique. The camera 521 and image processing modules 522 may be implemented to interact with various other modules of device 500. For example, the combined image may be output on display output 503. In addition, the image processing module may be controlled via user inputs from user input module 505. User input module 505 may accept inputs to define a user preferences regarding the combined image. Memory 520 may be configured to store images, and may also store settings and instructions that determine how the camera and the device operate.

In the embodiment shown at FIG. 5, the device may be a mobile device and include processor 510 configured to execute instructions for performing operations at a number of components and can be, for example, a general-purpose processor or microprocessor suitable for implementation within a portable electronic device. Processor 510 may thus implement any or all of the specific steps for operating a camera and image processing module as described herein. Processor 510 is communicatively coupled with a plurality of components within mobile device 500. To realize this communicative coupling, processor 510 may communicate with the other illustrated components across a bus 550. Bus 550 can be any subsystem adapted to transfer data within mobile device 500. Bus 550 can be a plurality of computer buses and include additional circuitry to transfer data.

Memory 520 may be coupled to processor 510. In some embodiments, memory 520 offers both short-term and long-term storage and may in fact be divided into several units. Short term memory may store images which may be discarded after an analysis, or all images may be stored in long term storage depending on user selections. Memory 520 may be volatile, such as static random access memory (SRAM) and/or dynamic random access memory (DRAM) and/or non-volatile, such as read-only memory (ROM), flash memory, and the like. Furthermore, memory 520 can include removable storage devices, such as secure digital (SD) cards. Thus, memory 520 provides storage of computer readable instructions, data structures, program modules, and other data for mobile device 500. In some embodiments, memory 520 may be distributed into different hardware modules.

In some embodiments, memory 520 stores a plurality of applications 525. Applications 525 contain particular instructions to be executed by processor 510. In alternative embodiments, other hardware modules may additionally execute certain applications or parts of applications. Memory 520 may be used to store computer readable instructions for modules that implement scanning according to certain embodiments, and may also store compact object representations as part of a database.

In some embodiments, memory 520 includes an operating system 523. Operating system 523 may be operable to initiate the execution of the instructions provided by application modules and/or manage other hardware modules as well as interfaces with communication modules which may use wireless transceiver 512 and a link 515. Operating system 523 may be adapted to perform other operations across the components of mobile device 500, including threading, resource management, data storage control and other similar functionality.

In some embodiments, mobile device 500 includes a plurality of other hardware modules 501. Each of the other hardware modules 501 is a physical module within mobile device 500. However, while each of the hardware modules 501 is permanently configured as a structure, a respective one of hardware modules may be temporarily configured to perform specific functions or temporarily activated.

Other embodiments may include sensors integrated into device 500. an example of a sensor 552 can be, for example, an accelerometer, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the sensors 552 may be implemented as hardware, software, or firmware. Further, as described herein, certain hardware modules such as the accelerometer, the GPS module, the gyroscope, the inertial sensor, or other such modules may be used in conjunction with the camera and image processing module to provide additional information. In certain embodiments, a user may use a user input module 505 to select how to analyze the images.

Mobile device 500 may include a component such as a wireless communication module which may integrate antenna 515 and wireless transceiver 512 with any other hardware, firmware, or software necessary for wireless communications. Such a wireless communication module may be configured to receive signals from various devices such as data sources via networks and access points such as a network access point. In certain embodiments, compact object representations may be communicated to server computers, other mobile devices, or other networked computing devices to be stored in a remote database and used by multiple other devices when the devices execute object recognition functionality

In addition to other hardware modules and applications in memory 520, mobile device 500 may have a display output 503 and a user input module 505. Display output 503 graphically presents information from mobile device 500 to the user. This information may be derived from one or more application modules, one or more hardware modules, a combination thereof, or any other suitable means for resolving graphical content for the user (e.g., by operating system 523). Display output 503 can be liquid crystal display (LCD) technology, light emitting polymer display (LPD) technology, or some other display technology. In some embodiments, display module 503 is a capacitive or resistive touch screen and may be sensitive to haptic and/or tactile contact with a user. In such embodiments, the display output 503 can comprise a multi-touch-sensitive display. Display output 503 may then be used to display any number of outputs associated with a camera 521 or image processing module 522, such as alerts, settings, thresholds, user interfaces, or other such controls.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

It should be noted that the method as described herein may be implemented in software. The software may in general be stored in a non-transitory storage device (e.g., memory) and carried out by a processor (e.g., a general purpose processor, a digital signal processor, and the like.)

Having described several embodiments, it will therefore be clear to a person of ordinary skill that various modifications, alternative constructions, and equivalents may be used without departing from the spirit of the disclosure.

What is claimed is:

1. A method for generating a composite image by combining a first image of a scene with a second image of the scene, comprising:
generating a first weight mask for combining color information of a pixel in the first image with color information of a corresponding pixel in the second image, wherein the first image is taken with a first brightness degree and the second image is taken with a second brightness degree;
generating a second weight mask for combining intensity information of the pixel in the first image with intensity information of the corresponding pixel in the second image, wherein the first and the second weight masks are generated based on characteristics of a neighborhood around the pixel in the first and the second images; and
generating the composite image by combining color and intensity information of the pixel in the first and the second images using the first and the second weight masks.

2. The method of claim 1, wherein the characteristics of the neighborhood around the pixel comprise at least one of exposure, richness of color, sharpness and texture of a plurality of pixels in the neighborhood around the pixel.

3. The method of claim 1, wherein the first image is taken with flash and the second image is taken with ambient light.

4. The method of claim 3, wherein the first weight mask is biased towards the second image and the second weight mask is biased towards the first image.

5. The method of claim 1, wherein the first image is taken using a first ISO gain and the second image is taken using a second ISO gain.

6. The method of claim 5, wherein at least one of the first or the second images are taken with flash.

7. The method of claim 1, wherein the characteristics of the neighborhood around the pixel comprise information about a discount region with pixels that are affected by specular reflections.

8. An apparatus for generating a composite image by combining a first image of a scene with a second image of the scene, comprising:
means for generating a first weight mask for combining color information of a pixel in the first image with color information of a corresponding pixel in the second image, wherein the first image is taken with a first brightness degree and the second image is taken with a second brightness degree;
means for generating a second weight mask for combining intensity information of the pixel in the first image with intensity information of the corresponding pixel in the second image, wherein the first and the second weight masks are generated based on characteristics of a neighborhood around the pixel in the first and the second images; and
means for generating the composite image by combining color and intensity information of the pixel in the first and the second images using the first and the second weight masks.

9. The apparatus of claim 8, wherein the characteristics of the neighborhood around the pixel comprise at least one of exposure, richness of color, sharpness and texture of a plurality of pixels in the neighborhood around the pixel.

10. The apparatus of claim 8, wherein the first image is taken with flash and the second image is taken with ambient light.

11. The apparatus of claim 10, wherein the first weight mask is biased towards the second image and the second weight mask is biased towards the first image.

12. The apparatus of claim 8, wherein the first image is taken using a first ISO gain and the second image is taken using a second ISO gain.

13. The apparatus of claim 12, wherein at least one of the first or the second images are taken with flash.

14. The apparatus of claim 8, wherein the characteristics of the neighborhood around the pixel comprise information about a discount region with pixels that are affected by specular reflections.

15. A non-transitory processor-readable medium for generating a composite image by combining a first image of a scene with a second image of the scene comprising processor-readable instructions configured to cause a processor to:
generate a first weight mask for combining color information of a pixel in the first image with color information of a corresponding pixel in the second image, wherein the first image is taken with a first brightness degree and the second image is taken with a second brightness degree;
generate a second weight mask for combining intensity information of the pixel in the first image with intensity information of the corresponding pixel in the second image, wherein the first and the second weight masks are generated based on characteristics of a neighborhood around the pixel in the first and the second images; and
generate the composite image by combining color and intensity information of the pixel in the first and the second images using the first and the second weight masks.

16. The processor-readable medium of claim 15, wherein the characteristics of the neighborhood around the pixel comprise at least one of exposure, richness of color, sharpness and texture of a plurality of pixels in the neighborhood around the pixel.

17. The processor-readable medium of claim 15, wherein the first image is taken with flash and the second image is taken with ambient light.

18. The processor-readable medium of claim 17, wherein the first weight mask is biased towards the second image and the second weight mask is biased towards the first image.

19. The processor-readable medium of claim 15, herein the first image is taken using a first ISO gain and the second image is taken using a second ISO gain.

20. The processor-readable medium of claim 15, wherein the characteristics of the neighborhood around the pixel comprise information about a discount region with pixels that are affected by specular reflections.
